(19) United States
(12) Patent Application Publication
(10) Pub. No.: US 2026/0214417 A1
(43) Pub. Date: Jul. 23, 2026

(54) PERIODIC INTEGRATED SENSING WITH MOBILITY SUPPORT

(71) Applicant: InterDigital Patent Holdings, Inc., Wilmington, DE (US)

(72) Inventors: Jung Je Son, Warrington, PA (US); Achref Methenni, Montreal (CA); Samir Ferdi, Kirkland (CA); Ulises Olvera-Hernandez, Saint-Lazare (CA); Taimoor Abbas, Sainte-Julie (CA); Anuj Sethi, Ottawa (CA); Saad Ahmad, Montreal (CA)

(73) Assignee: InterDigital Patent Holdings, Inc., Wilmington, DE (US)

(21) Appl. No.: 19/137,212

(22) PCT Filed: Dec. 27, 2023
(86) PCT No.: PCT/US2023/085981

§ 371 Date: Jun. 9, 2025

Related U.S. Application Data
(60) Provisional application No. 63/435,907, filed on Dec. 29, 2022.

(51) Int. Cl. H04W 4/38; H04W 24/10; H04W 28/24

(52) U.S. Cl. CPC H04W 4/38; H04W 24/10; H04W 28/24

(57) ABSTRACT

A wireless transmit/receive unit (WTRU) with a processor and memory may be configured to receive a sensing request. The sensing request may indicate one or more parameters for performing a sensing operation, a sensing operation triggering condition, and a reporting triggering condition. The WTRU may be configured to determine that the sensing operation triggering condition is satisfied. Upon determining that the sensing operation triggering condition is satisfied, the WTRU may be configured to perform the sensing operation indicated in the sensing request. The WTRU may be configured to determine that the reporting triggering condition is satisfied. Upon determining that the reporting triggering condition is satisfied, the WTRU may be configured to send a sensing report based on the reporting triggering conditions and in accordance with the one or more sensing parameters indicated in the sensing request.

### CROSS-REFERENCE TO RELATED APPLICATIONS

This application claims the benefit of U.S. Provisional Patent Application No. 63/435,907 filed on Dec. 29, 2022, the entire contents of which are incorporated herein by reference.

### BACKGROUND

Sensing operations may include techniques for a collecting, analyzing, and interpreting of movement or environment-induced patterns in received electromagnetic signals. For example, sensing can be used to determine that objects are present based on measurements and/or interpretations of wireless signals.

Since electromagnetic signals, through cellular communication systems, are omnipresent, RF sensing has the potential to become a universal sensing mechanism with applications in smart home, retail, localization, gesture recognition, intrusion detection, etc. Specifically, existing cellular network installations might be dual-used for both communication and sensing. Such communications and sensing convergence is envisioned for future communication networks.

### SUMMARY

Methods and apparatuses may include performing periodic sensing service. A Sensing Service Request from an AF for Periodic Sensing Event and/or an Event Triggered Sensing Event. In examples, a 5GC may provide one or more periodic sensing report(s) in response of AF's request, for example, based on sensing area which may be fixed position or may vary per sensing time.

Methods and apparatuses may include a Wireless Transmit/Receive Unit (WTRU) initiated sensing operation which may be initiated by the WTRU's application itself and/or as a response on pending periodic sensing events and/or an event triggered sensing event.

For example, a wireless transmit/receive unit (WTRU) with a processor and memory may be configured to receive a sensing request. The sensing request may indicate one or more parameters for performing a sensing operation, a sensing operation triggering condition, and a reporting triggering condition. The WTRU may be configured to determine that the sensing operation triggering condition is satisfied. Upon determining that the sensing operation triggering condition is satisfied, the WTRU may be configured to perform the sensing operation indicated in the sensing request. The WTRU may be configured to determine that the reporting triggering condition is satisfied. Upon determining that the reporting triggering condition is satisfied, the WTRU may be configured to send a sensing report based on the reporting triggering conditions and in accordance with the one or more sensing parameters indicated in the sensing request.

In an example, the sensing operation triggering condition may be associated with one or more of a predetermined periodicity or one or more events. In an example, the sensing operation triggering condition may include one or more of a sensing period, entering a specific sensing service area location, or leaving a specific sensing service area location.

In an example, the reporting triggering condition may include one or more of a sensing period, entering a specific sensing service area location, leaving a specific sensing service area location, or a detection of an event. The detection of the event may be based on a result of the sensing operation.

In an example, the sensing operation may include collecting sensing measurement data associated with one or more wireless signals in accordance with the one or more sensing parameters indicated in the sensing request.

In an example, the one or more parameters may include one or more of a periodicity for sending sensing reports, a start time for sending the sensing reports, an end time for sending the sensing reports, or a periodicity for performing a sensing operation.

In an example, the one or more parameters may include a sensing request type, region information associated with the sensing operation, information associated with a target WTRU, a Quality of Service (QoS) requirement associated with the sensing operation, or a sensing report type.

The sensing report type may be a periodic sensing report, and the sensing request further comprises a sensing report start time, a sensing report ending time, and a periodicity of sensing report.

The sensing report type may be an event triggered sensing report, and the sensing request may further include a sensing report start time, a sensing report ending time, and the sensing report triggering condition.

The QoS requirement associated with the sensing operation may include a sensing accuracy, a latency, a sensing frequency, or a resolution.

In an example, a method implemented by a wireless transmit/receive unit (WTRU) may include receiving a sensing request. The sensing request may indicate one or more parameters for performing a sensing operation, a sensing operation triggering condition, and a reporting triggering condition. The method may include determining that the sensing operation triggering condition is satisfied.

The method may further include upon determining that the sensing operation triggering condition is satisfied, performing the sensing operation indicated in the sensing request. The method may also include determining that the reporting triggering condition is satisfied.

The method may further include upon determining that the reporting triggering condition is satisfied, sending a sensing report based on the reporting triggering conditions and in accordance with the one or more sensing parameters indicated in the sensing request.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a diagram of an example of a reference model of 5G/NextGen Network.

FIG. 3 depicts a diagram of an example of pedestrian/animal intrusion detection.

FIG. 4 depicts a diagram of an example of intruder detection in surroundings of a smart home.

FIG. 5 depicts a diagram of an example of sensing service in vehicle navigation.

FIG. 6 depicts a flowchart illustrating an example of periodic sensing request with target service area.

FIG. 7 depicts a flowchart illustrating an example of periodic sensing request with target WTRU.

FIG. 8 depicts a flowchart illustrating an example of a WTRU initiated sensing request.

### DETAILED DESCRIPTION

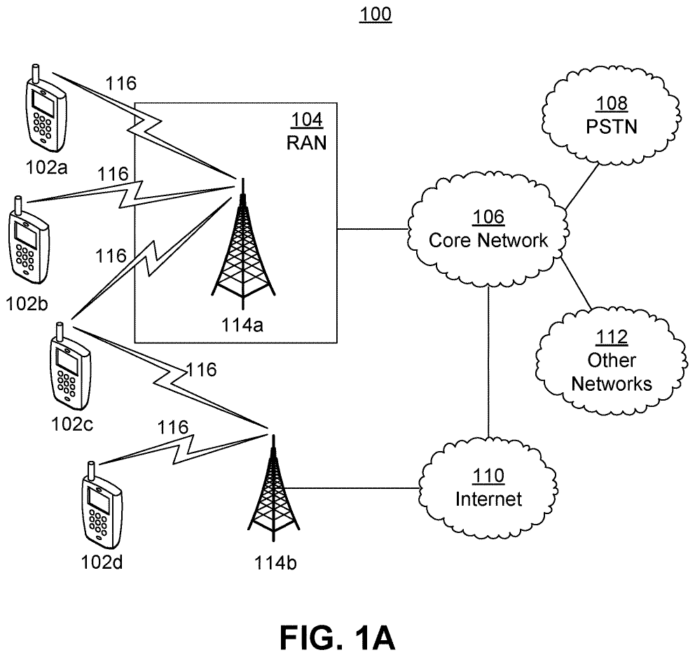

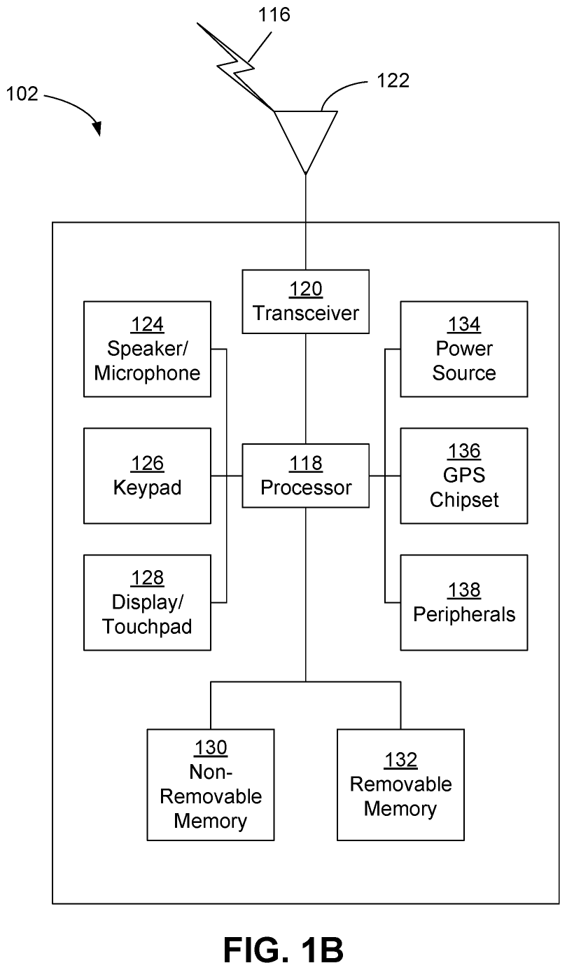

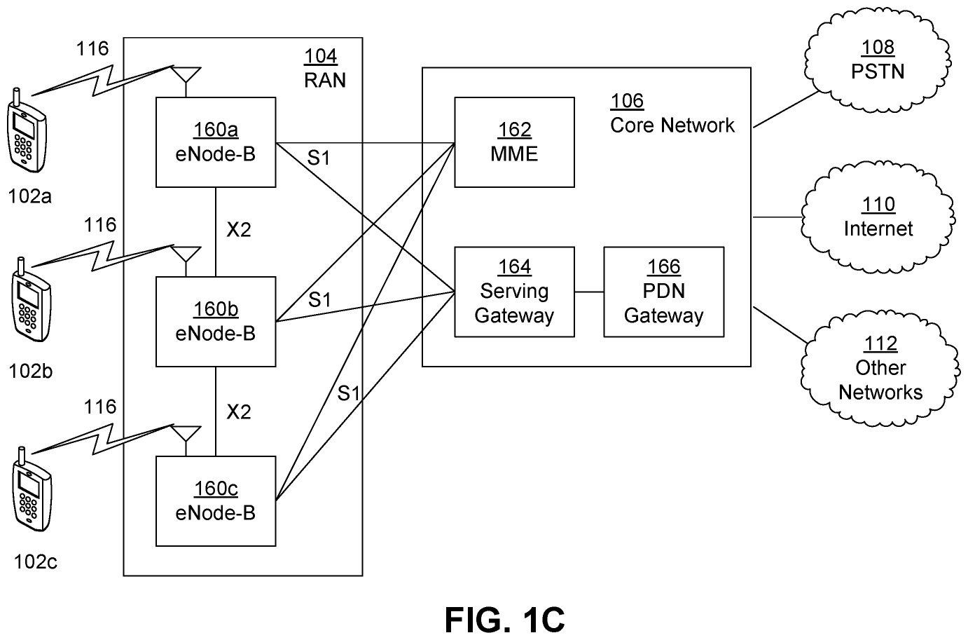

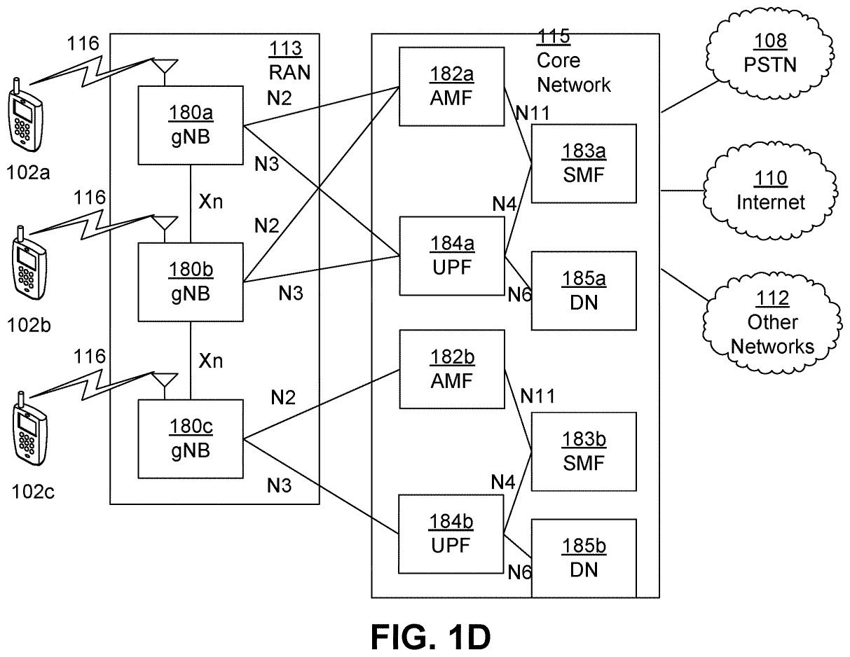

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102.

For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum.

According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUS 102a, 102b, 102c in a standalone configuration and/or a non-standalone configuration. In the standalone configuration, WTRUs 102a, 102b, 102c may communicate with gNBs 180 a, 180 b, 180 c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c.

For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

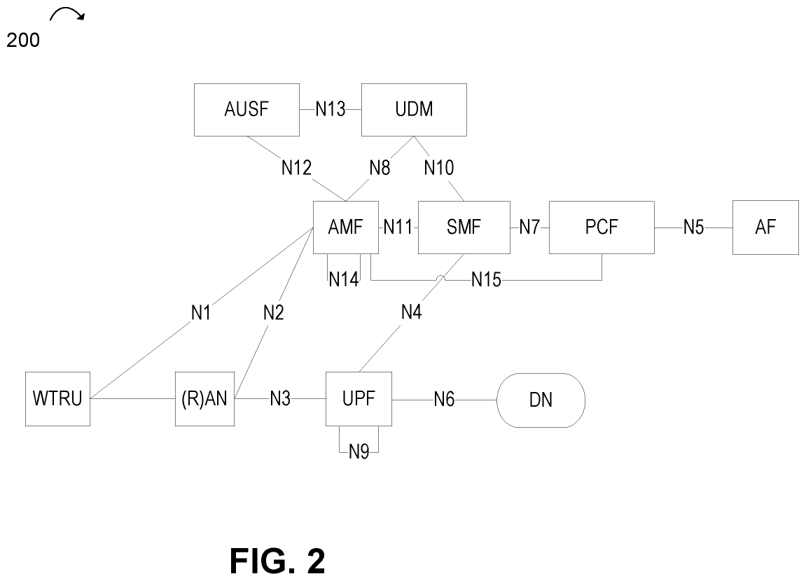

FIG. 2 may depict an example of a reference model of a potential architecture 200 of 5G and/or NextGen network. RAN here may refer to a radio access network based on the 5G RAT and/or Evolved E-UTRA that connects to the NextGen core network. The Access Control and Mobility Management Function (AMF) may include one or more of the following functionalities: Registration management, Connection management, Reachability management, Mobility Management, etc. The Session Management Function (SMF) may include one or more of the following functionalities: session management (e.g., including session establishment, modify and/or release), WTRU IP address allocation, selection and/or control of UP function, etc. The User plane function (UPF) may include one or more of the following functionalities: packet routing and/or forwarding, packet inspection, traffic usage reporting, etc.

Enhancement of the 5G system may include integrated sensing. Integrated sensing may include providing sensing services addressing different target verticals and/or applications (e.g., autonomous/assisted driving, V2X, UAVs, 3D map reconstruction, smart city, smart home, factories, healthcare, maritime sector). For integrated sensing, there may be a process of collecting sensing measurement data. Sensing measurement data may include data collected about radio/wireless signals impacted (e.g., reflected, refracted, diffracted) by an object and/or environment of interest for sensing purposes. Sensing data may include deriving sensing results from processing sensing measurement data. Integrated Sensing may include an area defined for sensing. The area defined for sensing may be referred to as a sensing service area location. The 5G system may provide sensing service within certain quality within the sensing service area location. Integrated Sensing may include other N3GPP entities. The sensing measurement data may be considered as transparent to 5GS such that the data may communicated using a protocol to an interface included in the 5GS.

Integrated sensing may be performed in one or more use cases. A use case for integrated sensing may be object detection. For example, a use case may include object detection for pedestrian/animal intrusion detection on a highway and/or intruder detection in surroundings of a smart home.

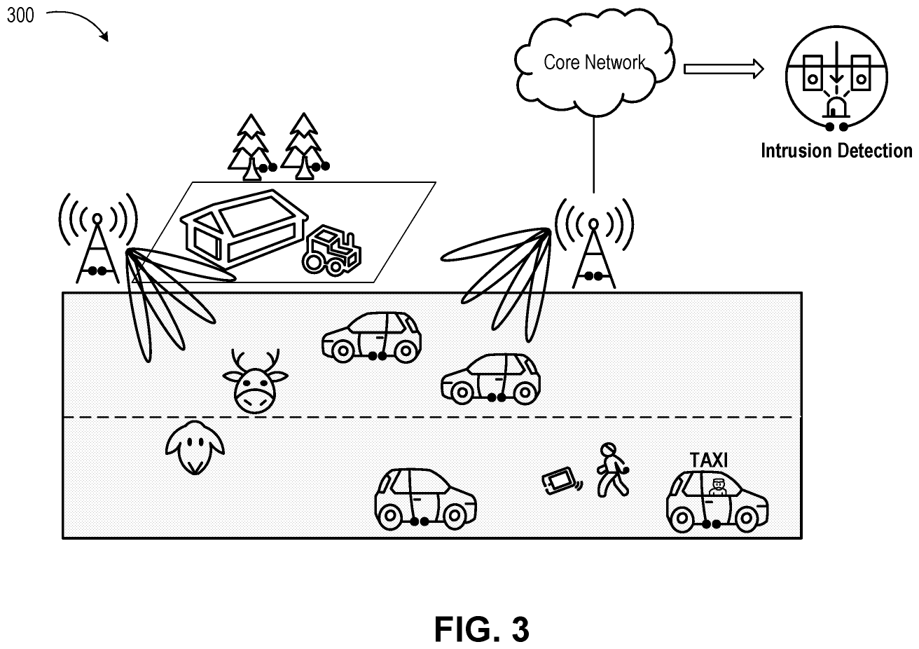

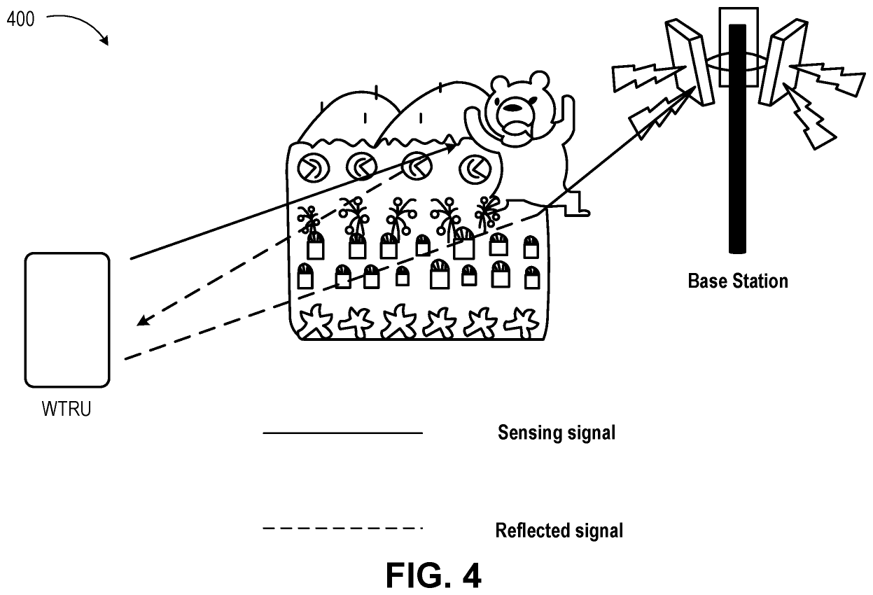

FIG. 3 depicts a diagram illustrating an example of the use case of pedestrian/animal intrusion detection 300. FIG. 4 depicts a diagram illustrating an example of a use case of intruder detection 400 in surroundings of a smart home. In examples, the base station (BS) and/or WTRU may detect the intrusion on the sensing area of a base station by itself and/or by collaboration between the WTRU and the base station. When used here, the term WTRU may be used to a user equipment and/or a base station device that is configured to perform a sensing operation. The sensing measurement may be transferred to the network and/or further processed into the sensing result.

One or more uses cases with respect to periodic sensing service(s) may include sensing that includes periodic information update. For example, weather condition monitoring (e.g., rain, snow) at a sensing service area may include sensing information being monitored periodically by involved base stations and/or WTRUS at the sensing service area.

Another example of periodic sensing service(s) that may include updating information periodically is traffic condition monitoring. Traffic condition monitoring may be used as a driving assistance of vehicle and/or navigation system. The traffic condition may be updated periodically and/or a new traffic condition may be provided per the vehicle's updated location and/or expected route. In examples, the vehicle's position may be different by user's choice on the route per traffic condition, for each sensing event, the sensing service area and/or the involved base station and/or WTRU's included to be checked.

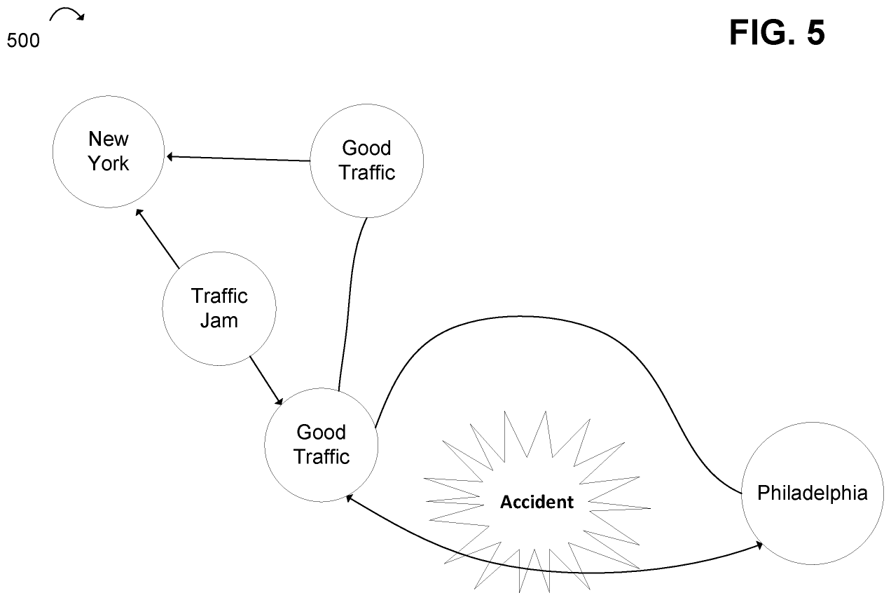

FIG. 5 depicts a diagram of an example of a sensing service 500 in vehicle navigation. For example, a vehicle may be en route from the vehicle's origin location to a destination. The origin may be New York. The destination may be Philadelphia. En route, the vehicle may encounter traffic conditions. In examples, traffic condition monitoring may include a traffic jam, an accident, a road hazard, etc. FIG. 5 depicts a diagram illustrating an example of a vehicle encountering a traffic jam and an accident en route from New York to Philadelphia.

Providing periodic sensing may include the 5GC system being able to provide one or more mechanism(s) to address one or more of the following: How may an application function request periodic sensing service to be understandable at the 5GC; How to support periodic sensing service with fixed sensing service area in 5GC; and/or how to support periodic sensing service with variable sensing service area in 5GC.

Methods and apparatuses may include the operation for periodic sensing events. Methods and apparatuses may include the case when the serving area for sensing is fixed. Methods and apparatuses may include the operation for periodic sensing when the serving area is determined at the time of sensing.

Methods and apparatuses may include WTRU initiated sensing operation which may be initiated by WTRU's application itself and/or as a response on pending periodic sensing events.

Methods and apparatuses for handling sensing service may include that there are several network functions such as Integrated Sensing Assistance NF (ISANF) and Sensing Operation Management Function (SOMF). ISANF and/or SOMF may be logical entity and/or may be collocated with another entity. For example, NEF and ISANF and SOMF may be implemented at the same entity. SOMF may include a processor.

ISANF may oversee the interaction with Application Function for sensing service. ISANF may understand the service request from Application Function and/or may derive the corresponding requested sensing mechanism. Additionally or alternatively, the ISANF may forward the request to the AMF which serves the requested region and/or requested entities, for example, after determining requested sensing mechanism. The ISANF may receive the report on sensing directly from AMF and/or from other Network Entity (e.g., Sensing Operation Management Function (SOMF)) and/or the ISANF may report the result to the Application Function.

Application Function and ISANF may communicate through NEF(Network Exposure Function), for example, when Application Function is a 3rd party application which is not a trusted entity of 5GS.

SOMF may be handling coordination of sensing operation among BS and WTRUs. SOMF may receive a WTRU initiated sensing request from a network node. The WTRU initiated sensing request may include a requested sensing area, a requested service area, a WTRU location, information associated with SOMF, and/or a periodic service request. Based on information received from AMF for example requested sensing region, for example, the BSs and WTRUs'list, and/or requested sensing mechanism with QoS requirement, the SOMF may derive coordination information for sensing operation. The SOMF may select a WTRU to perform a sensing operation based on the WTRU initiated sensing request. For example, the SOMF may decide the role of sensing operation such as sender(s) of sensing signal(s), receiver(s) of sensing signal(s), entity to collect the sensing measurement data, and/or entity to calculate sensing result. For example, the SOMF may decide sensing period, the waveform of sensing signal and/or ask BS(s) and/or sender(s) resource assignment for sending sensing signal at the sensing period.

The service request from AF may include different type of sensing report such as one time sensing report, periodic sensing service report, and/or event triggered sensing service report.

For a service request requesting multiple sensing report such as periodic sensing service report and/or event triggered sensing service report, each sensing report may request the sensing result on different sensing service area location.

Periodic Sensing may include requesting with target service area.

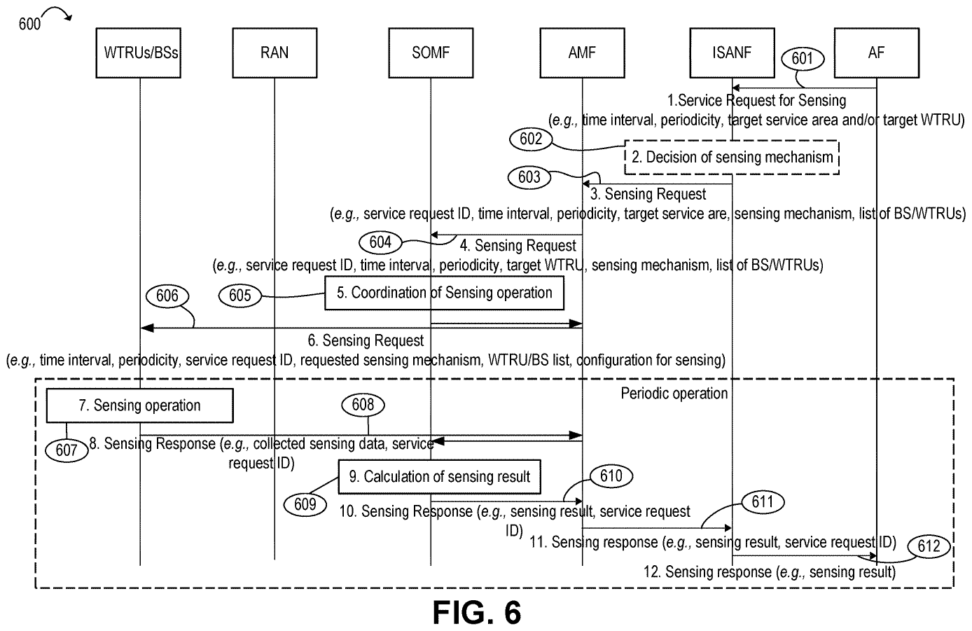

FIG. 6 illustrates a flowchart that depicts an example of periodic sensing with target service area 600. At 601, the AF may transmit a message to the ISANF. The message may include a service request for sensing or a sensing request. The service request or sensing request may include specific type of sensing request (e.g., intrusion detection, raining detection, drone detection, etc.) and/or region information in which the sensing may be performed, for example, when a service request for sensing or sensing request comes from AF. The message may include the WTRU's information which may perform sensing (e.g., collecting sensing measurements data). The service request or the sensing request may include specific QoS requirements on the sensing service, e.g., sensing accuracy, latency, sensing frequency, resolution, etc.

The service request or the sensing request may include sensing report type such as one time service report, periodic sensing service report, and/or event triggered sensing service report.

Periodic service report may include the sensing report start time, sensing report ending time and/or periodicity of sensing report, for example, when periodic sensing service report is requested.

Event triggered sensing service report may include the sensing report start time, sensing report ending time and/or sensing report triggering condition (e.g., entering a specific sensing service area location, leaving a specific sensing service area location, detection of an event such as intrusion detection, raining detection, etc.), for example, when event triggered sensing service report is requested.

The WTRU's request in the application layer may trigger the service request for sensing or the sensing request from AF. The WTRU's application may send a sensing request to the AF and/or application server which may include parameters such as requested sensing region, requested sensing service type, and/or target WTRU's information. The Service Request for sensing or sensing request may include time interval, target service area, and/or target WTRU. Based on the WTRU's request, for example, the AF may build serving request message for sensing or sensing request to be sent to the ISANF.

At 602, the assistance NF may translate the service request or sensing request into the requested sensing mechanism included to be performed in 5GS, (e.g., BS only based sensing, BS and WTRU collaboration-based sensing, WTRU only based sensing, etc.).

Additionally or alternatively, the ISANF may refer to the Policy Control Function (PCF) to check the Service Level Agreement (SLA) on service requested by the AF and/or decide whether the requested sensing service or sensing request and/or which QoS determination or requirement on the requested sensing service or sensing request may be supported.

The ISANF may derive the candidate list of BSs and/or WTRUs performing sensing mechanism on the requested area, for example, if the request is for sensing data on a fixed sensing service area location.

Alternatively or additionally, the ISANF may request the AMF to derive the sensing service area according to the target WTRU's location and/or provide a list (e.g., complete list) of tracking area identities (TAIs) and/or list of BSs (e.g., gNB IDs) for one or more (e.g., all) the associated sensing capable WTRUs. Based on the reported target WTRU's location, for example, the ISANF may determine sensing service area and/or the ISANF may select and/or derive the candidate list of BSs and/or WTRUs performing sensing mechanism on the determined sensing service area. Additionally or alternatively, the ISANF may request the AMF to provide a candidate list of BSs and/or WTRUs capable of sensing according to the requested sensing service area and/or based on the target WTRU's identities and/or location. In examples, there may be extra signaling between the ISANF and AMF to query sensing service area information and/or list of BSs and/or WTRU's per sensing service area and/or target WTRU's location.

Additionally or alternatively, based on capabilities of each BS and/or WTRU, for example, the ISANF may decide the sensing mechanism and/or list of BS and/or WTRU(s) to perform the sensing mechanism. The one or more N3GPP sensing capability(ies) may also be considered to choose proper sensing mechanism which may utilize the N3GPP sensing data, for example, if there is any WTRU supporting N3GPP sensing method.

At 603, the ISANF may send a Nisanf_Sensing Request message to the AMF which serve the target WTRU and/or which serve the requested Region and/or are connected with and/or controlling the BS and/or WTRU(s) in the list of BSs and/or WTRUs to perform the sensing. The Sensing Request may include requested sensing report type, requested sensing region information (e.g., list of TAIs, list of cell IDs), list of BSs (e.g., gNB IDs) and/or list of WTRUs, application ID and/or requested sensing mechanism with QoS determination or requirement.

Alternatively or additionally, the ISANF may include target SOMF in the message, for example, when the ISANF knows the SOMF′ service area.

The service request or sensing request may include one or more related parameter(s) for the requested sensing report type, for example, when the requested sensing report type is for periodic sensing service report and/or event triggered sensing service report. For example, for periodic sensing service report, sensing report start time, sensing report ending time and/or periodicity of sensing report may be included. Parameters for periodic sensing may include a start time, an ending time, and/or a periodicity of sensing. The sensing request may include a sensing report start time, a sensing report ending time, and a periodicity of sensing report, for example, when the sensing report type is the periodic sensing report. For example, for event triggered sensing service report, sensing report start time, sensing report ending time and/or sensing report triggering condition may be included. The sensing request may include a sensing report start time, a sensing report ending time, and the sensing report triggering condition, for example, when the sending report is the event triggered sensing report.

One or more parameters of sensing request may include a periodicity for sending sensing reports, a start time for sending the sensing reports, an end time for sending the sensing reports, and/or a periodicity for performing a sensing operation.

A sensing request may include a periodicity for performing a sensing operation, a periodicity for sending sensing responses, and/or a requested sensing mechanism.

The ISANF may manage service request ID so that ISANF may map the requested sensing service or sensing request and/or the recipient of sensing service and/or service request ID may be included in Nisanf_Sensing Request message.

At 604, the AMF may send Namf_Sensing Request message to the SOMF, for example, after receiving the Nisanf_Sensing Request from the ISANF. The Namf_Sensing Request message may include requested sensing report type and/or one or more related parameter(s), service request ID, requested sensing mechanism with QoS determination or requirement, list of BSs and/or WTRUs involved, application ID and/or target area.

Alternatively or additionally, the BSs and WTRUs'list and/or sensing mechanism may be decided by the SOMF and/or the AMF. For example, when AMF/SOMF decides the sensing mechanism and/or BSs and/or WTRUs'list, the AMF/SOMF may determine candidate BSs and/or WTRUs'list based on requested sensing region information. Alternatively or additionally, the AMF/SOMF may determine sensing mechanism and/or target BSs and/or WTRUs'list based on, for example, requested sensing mechanism with QoS determination or requirement, and/or capability of entities and/or allowed and/or restricted application list for sensing of each entity(ies) in the candidate list. In examples, the ISANF/AMF may include requested sensing region information, but not include list of BSs and WTRUs and/or sensing mechanism in the Nisanf_Sensing Request and/or Namf_Sensing Request. Requested sensing mechanism may be an event-based QoS determination or requirement.

The list of BSs and/or WTRUs involved in Namf_Sensing Request may be different from the BSs and WTRUs'list in Nisanf_Sensing Request message as AMF may down select per WTRU's and/or BS's state and/or circumstance, e.g., resource load, WTRU's capability on sensing operation, WTRU's mobility state such as idle mode, connected mode, and/or connected but RRC-Inactive mode.

The AMF may coordinate with PCF and/or Unified Data Management (UDM) for checking policy configuration on candidates WTRU's capability, for example, the list of allowed and/or disallowed application IDs for sensing operation by the WTRU. Based on coordination with PCF and/or UDM, the AMF may down select the list of WTRUs for sensing operation.

At 605, the SOMF may develop coordination information for controlling the sensing operation of BSs and/or WTRUs in the list according to the requested sensing mechanism and/or QoS determination or requirement, e.g., the SOMF may decide the role of sensing operation such as sender(s) of sensing signal(s), receiver(s) of sensing signal(s), etc. and/or may decide sensing period, and/or the waveform of sensing signal.

Alternatively or additionally, the SOMF may derive the BSs and/or WTRU's list for sensing operation according to the requested sensing service area and/or may develop coordination information for controlling the sensing operation of BSs and/or WTRUs in the list according to the requested sensing mechanism and/or QoS determination or requirement, for example, if the BSs and/or WTRU's list may not be provided.

The SOMF may coordinate with PCF and/or UDM for checking policy configuration on candidates WTRU's capability, for example the list of allowed and/or disallowed application IDs for sensing operation by the WTRU. Based on coordination with PCF and/or UDM, the SOMF may down select the list of WTRUs for sensing operation.

The SOMF may request BS(s) resource assignment for sending sensing signal at the sensing period. Time period and/or periodicity may be included in the request when resource assignment for periodic sensing operation is requested.

Alternatively or additionally, resource assignment for sending sensing signal may be decided by BS(s) sensing signal and/or may be informed the another entity, e.g., BSs and/or WTRUs in the list.

At 606, the SOMF may send the Sensing Request to the one or more entity(ies) involved in the sensing operation, such as a WTRU. The SOMF may send the sensing request through AMF using a non-access stratum (NAS) container, for example, when sending Sensing Request to the WTRU is involved. SOMF may send the sensing request using direct communication between SOMF and BS and/or through AMF using N2 connection, for example, when sending Sensing Request to the BS involved. The Sensing Request may include time interval, periodicity, service request ID, requested sensing mechanism, WTRU/BS list, and/or configuration for sensing. The Sensing Request message may include the ID or Address of SOMF as serving SOMF information. The Sensing Request may indicate parameters for performing a sensing operation, a sensing operation triggering condition, and a reporting triggering condition.

The Sensing Request message for the WTRU and/or Sensing Request message for BS may include different information. For example, the Sensing Request message for the WTRU may include sensing area which the WTRU may use to sense, and/or the BS's information to which the WTRU may listen, etc. For example, the Sensing Request message for BS may include some configuration information, e.g., frame structure, resource assignment information, etc., and/or a list of BSs'information to coordinate to send sensing signal. Sensing requests may include a WTRU list, a base station list, and/or configuration information for performing sensing.

The sensing request may include the one or more parameter(s) for periodic sensing such as start time, ending time, periodicity of sensing so that involved BSs and/or WTRUs may conduct periodic sensing operations based on the coordination information, for example, when the requested sensing report type is for periodic sensing service report and/or event triggered sensing service report. The service request ID may be included in the Sensing Request, for example, when service request ID is received in Sensing Request. The Sensing Request message may include the ID or Address of SOMF as serving SOMF information. The Sensing Request may include two types of triggering conditions. WTRUs may determine that a sensing operation triggering condition is satisfied. Upon determining that the sensing operation triggering condition is satisfied, WRTUs may perform the sensing operation indicated in the sensing request. WTRUs may also determine that a reporting triggering condition is satisfied. Upon determining that the reporting triggering condition is satisfied, WTRUs may send a sensing report based on the reporting triggering conditions and in accordance with sensing parameters indicated in the sensing request.

Sensing request may include a periodicity for sending sensing reports, a start time for sending the sensing reports, an end time for sending the sensing reports, a periodicity for performing a sensing operation, sensing request type, region information associated with the sensing operation, information associated with a target WTRU, a Quality of Service (QoS) requirement associated with the sensing operation, or a sensing report type.

Sensing request may include a sensing report start time, a sensing report ending time, and a periodicity of sensing report, for example, when the sensing report type is a periodic sensing report. The sensing request may include a sensing report start time, a sensing report ending time, and the sensing report triggering condition, for example, when the sensing report type is an event triggered sensing report. The QoS requirement associated with the sensing operation may include a sensing accuracy, a latency, a sensing frequency, or a resolution.

At 607, the BSs and/or WTRUs may perform collecting sensing measurement data, for example, based on the coordination from SOMF. The sensing operation triggering condition may be associated with one or more predetermined periodicity(ies) or one or more event(s). The sensing operation triggering condition may include one or more of a sensing period, entering a specific sensing service area location, or leaving a specific sensing service area location. The sensing operation may comprise collecting sensing measurement data associated with wireless signals in accordance with sensing parameters indicated in the sensing request. For example, the sensing operation may include any combination of sending sensing signal from multiple BSs and/or WTRUS, and/or receiving sensing signal and measuring characteristics of received sensing signal at one or multiple Bs and/or WTRUs. The sensing measurement data may include the measured characteristics of one or multiple sensing signals, such as for example, signal strength, channel state information (CSI), a transmission delay, and/or a number of multiple paths.

At 608, the BSs and/or WTRUs may send the a sensing response that includes collected sensing measurement data to the SOMF. The sensing response sent to the SOMF may include a service request ID. The sensing response may be sent to the SOMF that is indicated by the serving SOMF information, for example, if the serving SOMF information is received in the sensing request by one or more entity(ies) involved in the sensing operation. The collected sensing measurement data may be collocated at a WTRU and/or a BS and/or a sensing response including the collocated sensing measurement data may be sent to the SOMF. The entity that collects the sensing measurement data may be indicated in coordination information.

The WTRU may send the sensing response to the SOMF when the reporting triggering conditions are met. The reporting triggering condition may include one or more of a sensing period, entering a specific sensing service area location, leaving a specific sensing service area location, and/or a detection of an event. The detection of the event may be based on a result of the sensing operation. The sensing response may include parameters relating to collected sensing measurement data, for example, a start time for sensing measurement, an end time for sensing measurement, a periodicity for sensing measurement, a start time for sensing report, an end time for sensing report, and/or an identification of a network element and/or WTRU (e.g., a BS ID or WTRU ID) that performed the sensing measurement.

At 609, the SOMF may calculate sensing result using the collected sensing measurement data received.

At 610, the SOMF may send the sensing result to the AMF via Namf_Sensing Response. The service request ID may be included, for example, if the service request ID is received by the SOMF in the collected sensing measurement data. The SOMF may send sensing responses to a WTRU that initiated the WTRU-initiated sensing request via the network node.

The BSs and/or WTRUs may perform a sensing operation and/or send a sensing response to the SOMF per requested time interval and/or periodicity, for example, when periodic sensing operation is requested by the SOMF. Additionally or alternatively, the SOMF may perform a calculation of sensing result and/or send a sensing response to the AMF whenever the sensing response is received from WTRUs and/or BSs. The Sensing Response may include sensing result and/or service/sensing request.

Alternatively or additionally, one or more other entity(ies), for example one of BS and/or WTRU in the list and/or other dedicated network function may calculate the sensing result. For example, if a BS calculates sensing result, the collected sensing measurement data may be sent to the BS and/or the calculation result may be sent to the SOMF by the BS. If a BS calculates the sensing result, the SOMF may not calculate the sensing result.

At 611 and 612, the AMF may report the sensing result to the ISANF via Nisanf_Sensing Response, for example, after receiving the sensing result. Additionally or alternatively, the ISANF may report the sensing result to the AF via Service Response. The ISANF may decide the recipient AF based on service request ID which may be included in the sensing report from AMF and/or managed mapping between service request ID and recipient AF.

Alternatively or additionally, if calculation of sensing result is performed by AMF and/or ISANF, the SOMF may not perform the calculation of the sensing result and/or the collected sensing measurement data may be sent to the AMF via Namf_Sensing Response in the Sensing Response.

Periodic Sensing with target service area 600 may include updating BS's and/or WTRU's list per target WTRU's mobility. If the Sensing service area is derived from the target WTRU's location, for example, whenever the target WTRU moves, the WTRU's and/or BS's list for sensing operation may be updated (e.g., based on target WTRU's location). For example, when WTRU handover to other BS, and/or moves to another sensing service area, the event (e.g., handover to other BS, moving to another sensing service area) and/or new location information of the WTRU may be notified to AMF and/or SOMF (e.g., by new serving BS and/or by old serving BS). Additionally or alternatively, based on the updated target WTRU's location, for example, the AMF and/or SOMF may update BS's and/or WTRU's list for sensing operation and/or updated coordination information may be distributed to the BSs and/or WTRUs involved for sensing. Alternatively or additionally, during handover procedure and/or after handover, old serving base station and/or new serving base station for the WTRU may exchange one or more message(s) to update BS's and/or WTRU's list for sensing operation.

Periodic Sensing with target service area 600 may include controlling periodic sensing operation. Periodic sensing may be controlled with coordination of RAN. The ISANF and/or one or more other entity(ies) may inform periodic sensing operation ID as an alternative of periodic sensing parameter and/or as an additional parameter. For examples, there may be a separate signaling in broadcast manner (e.g., SIB from RAN, and/or by using MBS to indicate which sensing operation may be performed). The signaling may include sensing operation ID which may represent the sensing operation is to be enabled and/or disabled and/or the sensing operation ID may be correlated with sensing service area.

Methods and apparatuses may include periodic sensing request with target WTRU.

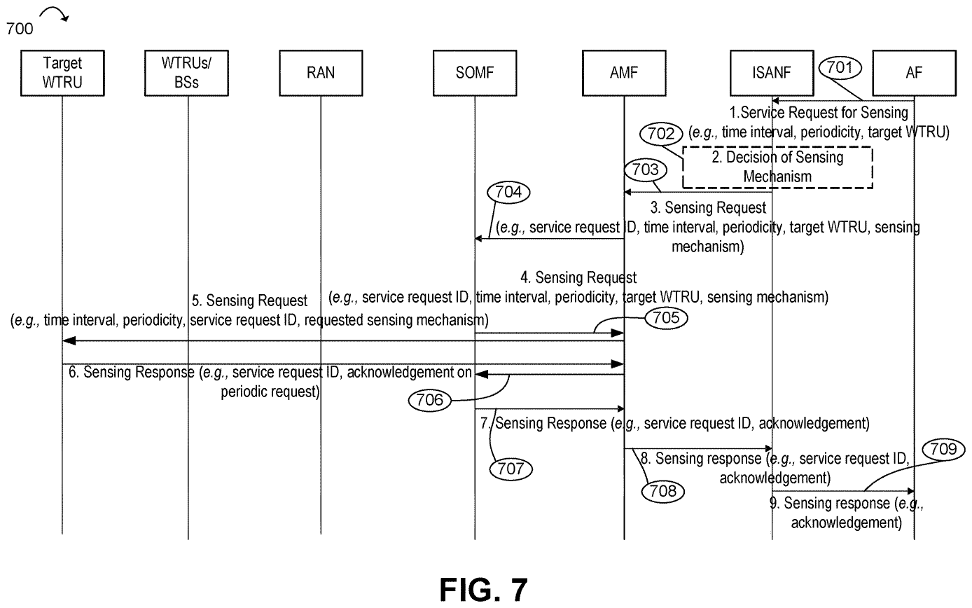

FIG. 7 depicts a flowchart illustrating an example of periodic sensing request with target WTRU 700. At 701, the service request for sensing or sensing request may include specific type of sensing request (e.g., intrusion detection, traffic monitoring, raining detection, drone detection, etc.), for example, when the service request for sensing or sensing request comes from AF. The service request or sensing request may include specific QoS determinations or requirements on the sensing service, (e.g., sensing accuracy, latency, sensing frequency, resolution, etc.). The QoS requirement associated with the sensing operation may include a sensing accuracy, a latency, a sensing frequency, and/or a resolution.

The sensing service area may be included, for example, when the sensing service is requested for a fixed sensing service area. The target WTRU information may be included, for example, when the sensing service is for a WTRU (e.g., target WTRU). Sensing service area may be determined according to the target WTRU's location at the time when sensing operation is performed, for example, when the target WTRU information is included but sensing service area is not included.

The service request or sensing request may include sensing report type such as one time service report, periodic sensing service report, and/or event triggered sensing service report. The sensing report type may be a one-time sensing report, a periodic sensing report, and/or an event triggered sensing report. Sensing report start time, sensing report ending time and/or periodicity of sensing report may be included, for example, when periodic sensing service report is requested. The Service request for sensing or sensing request may include time interval, periodicity, and/or target WTRU.

Sensing report start time, sensing report ending time and sensing report triggering condition (e.g., entering a specific sensing service area location, leaving a specific sensing service area location, detection of an event such as intrusion detection, raining detection, etc.) may be included, for example, when event triggered sensing service report is requested.

For each sensing event, the sensing service area may be determined based on target WTRU's location, for example, when periodic sensing service report and/or event triggered sensing service report is requested without sensing service area.

A WTRU may determine that a sensing operation triggering condition is satisfied. The sensing operation triggering condition may be associated with predetermined periodicities or events. The sensing operation condition may have a sensing period, entering a specific sensing service area location, leaving a specific sensing service area location or detection of an event.

At 702, an NF may perform decision of sensing mechanism. The NF may be an ISANF. The assistance NF may translate the service request or sensing request into the requested sensing mechanism to be performed in 5GS (e.g., BS only based sensing, BS and WTRU collaboration-based sensing, WTRU only based sensing, etc.).

Additionally or alternatively, the ISANF may refer to the PCF to check the SLA on service requested by AF and/or decide whether requested sensing service or sensing request and/or which QoS determination or requirement on the requested sensing service or sensing request may be supported.

At 703, the ISANF may send a Nisanf_Sensing Request message to the AMF that is serving the target WTRU. The Sensing Request may include requested sensing report type, requested sensing region information, target WTRU ID, application ID, and/or requested sensing mechanism with QoS determination or requirement. The Sensing Request may include service request ID, time interval, periodicity, target WTRU, and/or sensing mechanism.

The sensing request may include a sensing request type, region information associated with the sensing operation, information associated with a target WTRU, a Quality of Service (QoS) requirement associated with the sensing operation, and/or a sensing report type.

When the requested sensing report type is for periodic sensing service report (periodic sensing report) and/or event triggered sensing service report (event triggered sensing report), the service request or sensing request may include one or more related parameter(s) for the requested sensing report type. For example, for periodic sensing service report, sensing report start time, sensing report ending time and/or periodicity of sensing report may be included. For event triggered sensing service report, sensing report start time, sensing report ending time and/or sensing report triggering condition may be included. The sensing report may include time interval, periodicity, service request ID, and/or requested sensing mechanism.

The ISANF may manage service request ID so that ISANF may map the requested sensing service and/or the recipient of sensing service and/or service request ID may be included in Nisanf_Sensing Request message.

At 704, the AMF may send Namf_Sensing Request message to the SOMF, for example after receiving the Nisanf_Sensing Request from the ISANF. The Namf_Sensing Request message may include requested sensing report type and/or one or more relating parameter(s), service request ID, requested sensing mechanism with QoS determination or requirement, application ID, and/or target WTRU ID.

At 705, the requested sensing service area may be determined when the sensing operation is performed as requested by the relating parameters on periodic sensing service report and/or event triggered sensing service report, for example, when the requested sensing report type is for periodic sensing service report and/or event triggered sensing service report without sensing service area and/or list of BS's and/or WTRU's for sensing operation provided.

The SOMF may send Sensing Request to the target WTRU to perform WTRU initiated sensing procedure for periodic sensing and/or event triggered sensing, for example, when the requested sensing is periodic sensing or event triggered sensing with sensing service area per target WTRU's location.

The Sensing Request message may include requested sensing report type and/or indicating/relating parameter(s) (e.g., for periodic sensing such as start time, ending time, periodicity of sensing), service request ID, serving SOMF information, requested sensing mechanism with QoS determination or requirement, application ID, and/or target WTRU ID. A WTRU-initiated sensing request may include a requested sensing report type, parameters for periodic sensing, a service request ID, requested sensing mechanism with a QoS requirement, a list of base stations and WTRUs involved, an application ID, a target area, and/or an address of SOMF. An indication of a target area or a WTRU/BS list may be received from an AMF.

The service request ID may be included in the Sensing request sent from the SOMF, for example, when the service request ID is received from the AMF. The Sensing Request message may include the ID and/or Address of SOMF as serving SOMF information.

The SOMF may send the Sensing Request through the AMF using NAS container, for example, when sending the Sensing Request to the target WTRU. A WTRU initiated sensing request may be received from a WTRU via an AMF.

At 706, the Target WTRU may send a Sensing Response. The Sensing Response may include service request ID and/or acknowledgement on requested sensing service or sensing request (e.g., periodic request). The Sensing Response may be sent to AMF and/or SMF (e.g., if PDU session exists) and/or forwarded to the SOMF.

At 707, the SOMF may send a Sensing Response that includes service request ID and/or the acknowledgement to the AMF, for example, after receiving Sensing Response that may acknowledge the request for periodic sensing report and/or event triggered sensing report was accepted. At 708 and 709, the AMF may send an Sensing response (e.g., acknowledgement) to the ISANF and/or the ISANF may send an acknowledgement to the AF.

Methods and apparatuses may include WTRU initiated sensing request. A WTRU may request for sensing service to the AMF. The sensing service request or sensing request may be delivered to the AMF via UL NAS Transport.

The WTRU may be triggered for WTRU initiated sensing request as requested by periodic sensing report and/or based on one or more triggering condition(s) of event triggered sensing report, for example, when the WTRU has pending requested for periodic sensing report and/or event triggered sensing report. The Service Request for sensing may include requested sensing service or sensing request, requested service area and/or WTRU location, serving SOMF information, and/or service request ID.

A WTRU may include service request ID, for example, if the WTRU initiated sensing request is for pending periodic sensing report and/or event triggered sensing report which is relating to service request ID which is received during the Sensing Request procedure as described within methods and apparatuses. Additionally or alternatively, the WTRU may include serving SOMF information, for example, if the SOMF information was received during negotiation for periodic sensing report and/or event triggered sensing report (e.g., if the SOMF information is received during the Sensing Request procedure as described within methods and apparatuses with respect to periodic sensing request with target WTRU).

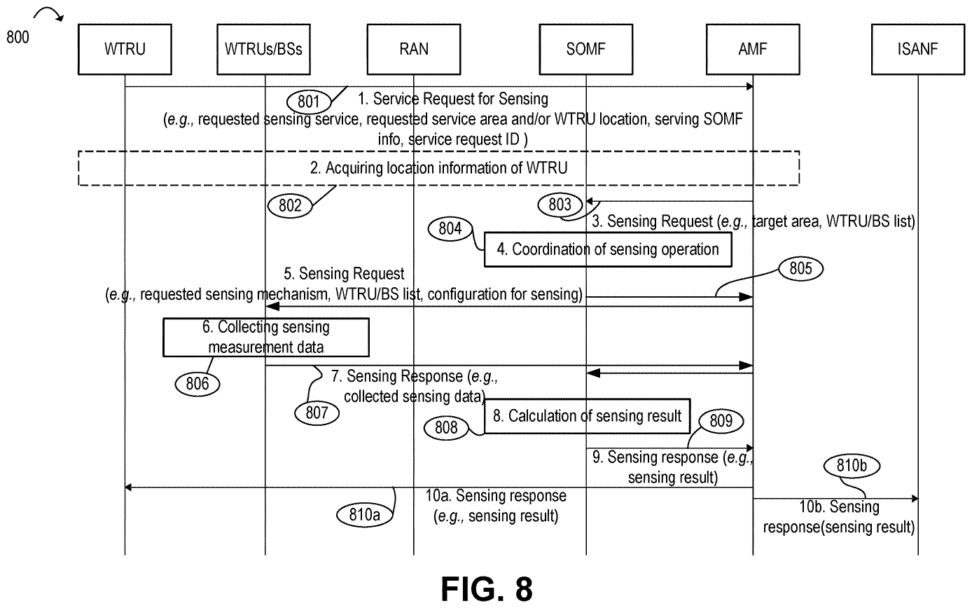

FIG. 8 depicts a flowchart illustrating an example of a WTRU initiated sensing request 800. At 801, a WTRU may send a Service Request for Sensing or sensing request. The Service Request for Sensing or sensing request may be included in a UL NAS Transport message. The Service Request for Sensing or sensing request may include specific type of sensing request (e.g., intrusion detection, raining detection, drone detection, etc., WTRU's ID, and/or region information in which the sensing may be executed or WTRU's location information). The service request or sensing request may include specific QoS determinations or requirements on the sensing service, e.g., sensing accuracy, latency, sensing frequency, resolution, etc.

A WTRU may include a service request ID, for example, if the request is relating to a pending periodic sensing report and/or event triggered sensing report which is represented by service request ID. Additionally or alternatively, a WTRU may include serving SOMF information, and/or sensing mechanism, for example, if the SOMF information and/or sensing mechanism was received during negotiation for periodic sensing report and/or event triggered sensing report.

Additionally or alternatively, a WTRU may include recipient of sensing services if the recipient of sensing services is not for WTRU itself and/or the service request ID is not included at Service Request or sensing request.

At 802, in examples, other procedures may receive the WTRU's location information.

At 803, based on sensing mechanism and/or sensing service area, the AMF may determine a list of BSs and/or WTRUs to perform sensing operation. The AMF may decide sensing mechanism may be performed in 5GS, for example, if sensing mechanism is not included in the service request for sensing or sensing request.

Alternatively or additionally, the AMF may ask the ISANF to determine sensing mechanism according to the requested serving service and/or to provide a list of BSs and/or WTRUs according to the sensing mechanism and/or requested sensing service area. Additionally or alternatively, the AMF may ask the ISANF to determine the sensing mechanism and/or provide a list of BSs and/or WTRUs as a separate procedure (e.g., before sending a sensing request to the SOMF).

Alternatively or additionally, the AMF and/or ISANF may decide the sensing mechanism and/or list of BS and/or WTRU(s) to perform the sensing mechanism based on the capability of BSs and/or WTRUs in the candidate list and/or requested sensing service with QoS determinations or requirements, for example, after deriving candidate list of BSs and/or WTRUs in the requested sensing service area. The N3GPP sensing capability(ies) also may be considered to choose proper sensing mechanism that may utilize the N3GPP sensing data, for example, if there is any WTRU supporting N3GPP sensing method.

The AMF may send Namf_Sensing Request message to the SOMF. The Namf_Sensing Request message may include service request ID, requested sensing mechanism with QoS determinations or requirements, list of BSs and/or WTRUs involved, application ID and target area.

The sensing service request or sensing request may be sent to the SOMF indicated in serving SOMF information, for example, if serving SOMF information is received in the service request for sensing or sensing request. Alternatively or additionally, the sensing service request or sensing request may be sent to another SOMF if the other SOMF may be able to perform the sensing operation. For example, a stronger sensing quality and/or stronger sensing performance may be included at another SOMF than the SOMF indicated at serving SOMF information based on WTRU's current location, requested sensing service area, and/or per SOMF condition such as load condition.

Alternatively or additionally, the BSs and/or WTRUs'list and/or sensing mechanism may be decided by the SOMF. In examples, the SOMF may determine candidate BSs and/or WTRUs'list based on requested sensing region information and/or determine a sensing mechanism and/or target BSs and/or WTRUs'list based on requested QoS determination or requirement of the sensing service, and/or capability of entities and/or allowed and/or restricted application list for sensing of each entities in the candidate list.

At 804, the SOMF may develop coordination information for controlling the sensing operation of BSs and/or WTRUs in the list according to the requested sensing mechanism and/or QoS determination or requirement, e.g., the SOMF may decide the role of sensing operation such as sender(s) of sensing signal(s), receiver(s) of sensing signal(s), etc. and/or may decide sensing period and/or the waveform of sensing signal. The SOMF may generate coordination information for controlling the sensing operation of one or more WTRUs of a WTRU list according to the requested sensing mechanism and a QoS requirement. A sensing operation may determine a sender of a sensing signal, determine a receiver of a sensing signal, determine a sensing period, and/or determine a waveform of a sensing signal.

The SOMF may include a processor. The SOMF may receive a WTRU-initiated sensing request from a network node. The WTRU-initiated sensing request may include one or more of a requested sensing area, a requested service area, a WTRU location, information associated with a serving SOMF, or a periodic service request. The SOMF may select one or more WTRUs to perform a sensing operation based on the WTRU-initiated sensing request. The SOMF may send one or more sensing requests to the one or more selected WTRUs. The one or more sensing requests may include one or more of a periodicity for performing the sensing operation, a periodicity for sending sensing responses, or a requested sensing mechanism. The SOMF may receive one or more sensing responses from the one or more WTRUs. The one or more sensing responses may include sensing data. The SOMF may send the sensing responses to a WTRU that initiated the WTRU-initiated sensing request via the network node.

Alternatively or additionally, the SOMF may derive the BSs and/or WTRU's list for sensing operation according to the requested sensing service area and/or may develop coordination information for controlling the sensing operation of BSs and/or WTRUs in the list according to the requested sensing mechanism and/or QoS determinations or requirements, for example, if the BSs and/or WTRU's list is not provided.

The requested sensing mechanism may be an event-based QoS determination. The one or more sensing requests sent to the one or more WTRUs may include one or more of a WTRU list, a base station list, or configuration information for performing sensing.

Alternatively or additionally, resource assignment for sending sensing signal may be decided by BS(s) sensing signal and/or may be informed the other entity(ies), e.g., BSs and/or WTRUs in the list. The WTRU-initiated sensing request may be received from a WTRU via an access and mobility management function (AMF).

At 805, the SOMF may send a Sensing Request to the one or more entity(ies) involved in the sensing operation. The SOMF may send the Sensing Request through AMF using NAS container, for example, when sending Sensing Request to the WTRU involved. The SOMF may send the Sensing Request using direct communication between SOMF and BS and/or through AMF using N2 connection, for example, when sending the Sensing Request to the BS involved.

The Sensing Request message for WTRU and/or Sensing Request message for BS may include different information. For example, the Sensing Request message for the WTRU may include sensing area where the WTRU may sense, BS's information to which the WTRU may listen, etc. For example, the Sensing Request message for BS may include some configuration information (e.g., frame structure, resource assignment information, etc.,) and/or a list of BSs'information to coordinate to send sensing signal. Configuration information for performing sensing may be frame structure or resource assignment information.

The WTRU-initiated sensing request may include a requested sensing report type, parameters for periodic sensing, a service request ID, the requested sensing mechanism with a QoS requirement, a list of base stations and WTRUs involved, an application ID, a target area, or an address of SOMF. The requested sensing report type may be a periodic service report or an event triggered sensing service report. The parameters for periodic sensing may include a start time, an ending time, or a periodicity of sensing. The processor of the SOMF may receive an indication of a target area or a WTRU/BS list from an AMF. The processor of the SOMF may generate coordination information for controlling the sensing operation of one or more WTRUs of a WTRU list according to the requested sensing mechanism and a QoS requirement. The sensing operation may include determining a sender of a sensing signal, determining a receiver of a sensing signal, determining a sensing period, or determining a waveform of a sensing signal.

The service request ID may be included in the Sensing request, for example, when service request ID is received in the coordination of sensing operation. The Sensing Request message may include the ID and/or Address of SOMF as serving SOMF information.

At 806, based on the coordination from SOMF, the BSs and/or WTRUs may perform collecting sensing measurement data. The collected sensing measurement data may be sent to the SOMF. At 807, the collected sensing measurement data may be sent through AMF. The service request ID may be included in the report to the SOMF, for example, when the service request ID is received in the sensing request.

The sensing operation may comprise collecting sensing measurement data associated with wireless signals in accordance with sensing parameters indicated in the sensing request.

If the serving SOMF information is received in the Sensing Request from SOMF, the report may be sent to the SOMF (e.g., so called serving SOMF) which may be indicated by serving SOMF information. Otherwise, the report may be sent to the SOMF which sent the Sensing request. Alternatively or additionally, the report may be sent to the SOMF which sent the Sensing request and/or may be forwarded to the serving SOMF at the calculation of sensing result procedure.

At 808, the SOMF may calculate the sensing result using collected sensing measurement data received in the sensing response. The collected sensing data and/or calculated sensing result may be forwarded to the serving SOMF, for example, if the SOMF is different from the serving SOMF. The serving SOMF may calculate the sensing result, for example, if the serving SOMF received the collected data and did not receive the sensing result.

At 809, the SOMF may send a sensing response to the AMF. The Sensing response may include the sensing result. The SOMF may send the Sensing Response to the AMF via Namf_Sensing Response. The sensing response may include a Service request ID if Service request ID is received in the Sensing response sent from the WTRUs and/or BSs.

At 810a and 810b, the AMF may forward the sensing result to the recipient of sensing service if the recipient of sensing service is included in the request received in the service request for sensing or sensing request. The AMF may forward the sensing result and/or service request ID to the ISANF, for example, if sensing result includes the service request ID. The sensing result may be sent to the WTRU and/or the sensing result may be sent to the WTRU via NAS Transport, for example, if the sensing service is for the WTRU itself.

The ISANF may decide the recipient AF based on service request ID which may be included in the sensing report from AMF and/or managed mapping between service request ID and/or recipient AF and/or may send the sensing result to the decided AF.

Methods and apparatuses may include the consideration of SOMF Deployment. In examples, the SOMF may be deployed besides AMF and/or communication with SOMF and/or WTRU may be via AMF and/or sensing result from SOMF may be reported to ISANF, AF, and/or WTRU through AMF.

Additionally or alternatively, the SOMF may be deployed as server which may allow access by the WTRU via user plane. In examples, each WTRU involved for sensing may access the SOMF via data connection to retrieve the coordination information (e.g., role of each WTRU, list of involved BSs, role of each BS, the signal information needs to be monitored, etc.). Collected sensing data may be sent via data connection, for example, after collecting the sensing data. The Sensing Request sent from the SOMF via AMF to the WTRUs/BSs and/or the Sensing Response sent from the Target WTRU to the SOMF via AMF and/or the Sensing Report sent from WTRUS to the SOMF via AMF may be performed in data connection between SOMF and WTRU and between SOMF and Target WTRU, for example, when SOMF is deployed as server.

Additionally or alternatively, the SOMF may connect directly with the ISANF. Direct connection may be based on the SOMF's serving area being big enough and/or the ISANF may be aware of each SOMF's serving area. In examples, the ISANF may select the SOMF when sending sensing service request or sensing request to the AMF and/or let the AMF to send sensing request to the SOMF with the list of WTRU's and/or BS's for sensing. Alternatively or additionally, the ISANF may directly send a sensing request to the selected SOMF and/or the SOMF may query AMF available WTRU's info for sensing registered at the AMF in order to build WTRU's and/or BS's list for sensing. And when reporting sensing result, SOMF may directly sends the report to the ISANF.

With respect to Periodic Sensing request with target service area one or more of the following may be replaced with direct signaling exchange between SOMF and ISANF and/or an interaction between SOMF and AMF may be added for retrieving BS's and WTRU's list and/or any relevant information: the sensing request sent from ISANF to AMF, the Sensing request sent from AMF to SOMF, the sensing response sent from SOMF to AMF, and the sensing response sent from AMF to ISANF.

With respect to Periodic Sensing request with target WTRU, one or more of the following may be replaced with direct signaling exchange between SOMF and ISANF and/or an interaction between SOMF and AMF may be added for retrieving BS's and WTRU's list and/or any relevant information: sensing request sent from ISANF to AMF, the sensing request sent from AMF to SOMF, the Sensing response sent from SOMF to AMF, and the sensing response sent from AMF to ISANF.

What is claimed is:

1-20. (canceled)

21. A wireless transmit/receive unit (WTRU) comprising:
a processor and memory, wherein the processor and memory are configured to:
receive a sensing request, the sensing request indicating one or more parameters for performing a sensing operation, a sensing operation triggering condition, a reporting triggering condition, and a service request identifier associated with the sensing operation, wherein the sensing operation is object detection, object tracking, or environment monitoring;
determine that the sensing operation triggering condition is satisfied;
upon determining that the sensing operation triggering condition is satisfied, perform the sensing operation indicated in the sensing request to determine sensing measurement data associated with one or more wireless signals in accordance with the one or more parameters indicated by the sensing request;
determine that the reporting triggering condition is satisfied; and
upon determining that the reporting triggering condition is satisfied, send a sensing report based on the reporting triggering conditions, wherein the sensing report comprises the sensing measurement data.

22. The WTRU of claim 21, wherein the sensing operation triggering condition
is associated with one or more of a predetermined periodicity or one or more events.

23. The WTRU of claim 22, wherein the sensing operation triggering condition
comprises one or more of a sensing period, entering a specific sensing service area location, or leaving a specific sensing service area location.

24. The WTRU of claim 21, wherein the reporting triggering condition comprises one or more of a sensing period, entering a specific sensing service area location, leaving a specific sensing service area location, or a detection of an event; and
wherein the detection of the event is based on a result of the sensing operation.

25. The WTRU of claim 21, wherein the one or more parameters comprise one or more of a periodicity for sending sensing reports, a start time for sending the sensing reports, an end time for sending the sensing reports, or a periodicity for performing the sensing operation.

26. The WTRU of claim 21, wherein the one or more parameters comprise a sensing request type, region information associated with the sensing operation, information associated with a target WTRU, or a sensing report type.

27. The WTRU of claim 27, wherein the sensing report type is a periodic sensing report, and the sensing request further comprises a sensing report start time, a sensing report ending time, and a periodicity of sensing report.

28. The WTRU of claim 27, wherein the sensing report type is an event triggered sensing report, and the sensing request further comprises a sensing report start time, a sensing report ending time, and the sensing report triggering condition.

29. The WTRU of claim 21, wherein the service request identifier allows an integrated sensing assistance network function to map a sensing service to the sensing service consumer.

30. The WTRU of claim 21, wherein the sensing request further indicates a requested sensing mechanism, wherein the requested sensing mechanism is based on a requested quality of service (QoS) defined by a sensing service consumer for the sensing operation.

31. The WTRU of claim 30, wherein the requested sensing mechanism comprises base-station-only-based sensing, a combination of base-station-based sensing and WTRU-collaboration-based sensing, or WTRU-only-based sensing.

32. The WTRU of claim 30, wherein the requested QoS comprises a sensing accuracy, a latency, a sensing frequency, or a resolution.

33. A method implemented by a wireless transmit/receive unit (WTRU), the method comprising:
receiving a sensing request, the sensing request indicating one or more parameters for performing a sensing operation, a sensing operation triggering condition, a reporting triggering condition, and a service request identifier associated with the sensing operation, wherein the sensing operation is object detection, object tracking, or environment monitoring;
determining that the sensing operation triggering condition is satisfied;
upon determining that the sensing operation triggering condition is satisfied, performing the sensing operation indicated in the sensing request to determine sensing measurement data associated with one or more wireless signals in accordance with the one or more parameters indicated by the sensing request;
determining that the reporting triggering condition is satisfied; and
upon determining that the reporting triggering condition is satisfied, sending a sensing report based on the reporting triggering conditions, wherein the sensing report comprises the sensing measurement data.

34. The method of claim 33, wherein the sensing operation triggering condition is associated with one or more of a predetermined periodicity or one or more events.

35. The method of claim 34, wherein the sensing operation triggering condition comprises one or more of a sensing period, entering a specific sensing service area location, or leaving a specific sensing service area location.

36. The method of claim 33, wherein the reporting triggering condition comprises one or more of a sensing period, entering a specific sensing service area location, leaving a specific sensing service area location, or a detection of an event; and
wherein the detection of the event is based on a result of the sensing operation.

37. The method of claim 33, wherein the one or more parameters comprises one or more of a periodicity for sending sensing reports, a start time for sending the sensing reports, an end time for sending the sensing reports, or a periodicity for performing the sensing operation.

38. The method of claim 33, wherein the one or more parameters comprises a sensing request type, region information associated with the sensing operation, information associated with a target WTRU, a requested Quality of Service (QoS) defined by a sensing service consumer for the sensing operation, or a sensing report type.

39. The method of claim 38, wherein the sensing report type is a periodic sensing report, and the sensing request further comprises a sensing report start time, a sensing report ending time, and a periodicity of sensing report.

40. The method of claim 38, wherein the sensing report type is an event triggered sensing report, and the sensing request further comprises a sensing report start time, a sensing report ending time, and the sensing report triggering condition.
